(19) United States
(12) Patent Application Publication
(10) Pub. No.: US 2010/0012428 A1
(43) Pub. Date: Jan. 21, 2010

(54) END COVER FOR A LADDER RAIL

(75) Inventors: Donald L. GIBSON, Louisville, KY (US); Abraham Gomez Lopez, Nuevo Leon (MX)

Correspondence Address: EGBERT LAW OFFICES, 412 MAIN STREET, 7TH FLOOR, HOUSTON, TX, 77002, US

(73) Assignee: Louisville Ladder Inc., Louisville, KY (US)

(21) Appl. No.: 12/176,367

(22) Filed: Jul. 19, 2008

(51) Int. Cl. E06C 7/48; E06C 7/00

(52) U.S. Cl. 182/108

(57) ABSTRACT

An end cover for a rail of a ladder has a body having a front and a back and a first side and a second side and a top and a bottom, a hole formed in the body adjacent the back and the top, a tread affixed to the front, at least one pocket formed is the bottom of the body for accommodating an end of the rail of the ladder, and a groove formed in the body that extends from the bottom to the top. A central planar portion extends downwardly from the bottom of the body. The tread is formed of an elastomeric material. The tread has gripper sections that extend outwardly from the front of a body.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to end covers for ladders. More particularly, the present invention relates to end covers that can grip external surfaces. Additionally, the present invention relates to end covers with handles.

2. Description of Related Art Including Information Disclosed Under 37 CFR 1.97 and 37 CFR 1.98

Ladders are commonly used as means for elevating persons to a specified height to perform a specified function. Users of ladders climb a series of steps, or rungs, to reach a desired height. All ladders are finite in height and have a top step which is the highest step and above which no other step exist. The prior art refers to this step as the ladder top. Ladder tops are typically adapted to fit the ladder body, which typically consists of two pairs of side rails and the rungs that extend perpendicularly between each pair of side rails. Ladders with ladder tops are self-supporting in that the ladder supports itself. That is, the ladder top is supported by both the first pair of side rails and the second pair of side rails.

Ladders with only one pair of side rails use extrinsic surfaces for support. Like all ladders, the pair of side rails are disposed in parallel-spaced relation and are interconnected by rungs extending perpendicularly therebetween. The upper ends of the side rails project upwardly from the uppermost rung a short distance so as to engage an extrinsic surface such as a vertical wall, the side of a building, and the like. The bottom ends of the pair of side rails are constructed so as to rest on another surface, such as the floor or the ground.

Ladders having only one pair of side rails are used by many professions, including painters, construction workers, and electricians. Frequently, these professions require the ladder user to rest the ladder against an extrinsic surface while climbing the ladder and while holding various tools and accessories so as to complete a given task. The weight of the ladder user, as well as the added weight of various tools and accessories, can make it difficult for the ladder user to balance on the ladder. As the user sways back and forth, the weight of the user can cause the ends of the rails of the ladder to move against the extrinsic surface. Thus, there is a need for an end cover for the rails of a ladder that holds the end of the ladder rails against an extrinsic surface. Moreover, there is a need for an end cover that has a handle that a ladder user can grab in the event the ladder user begins to lose his or her balance.

Another problem associated with using ladders against extrinsic surfaces is that the ends of the ladder rails can leave marks or damage the extrinsic surface. This is due to a rubbing of the ends of the rails against the extrinsic surface while the ladder user climbs on and off of the ladder. Thus, there is a need for an end cover for the rails of a ladder that protects the extrinsic surfaces from damage by the ladder.

Various patents have related to end covers for the rails of a ladder. For example, U.S. Pat. No. 1,600,103, issued on Sep. 15, 1926 to C. J. Evans, discloses an anti-slipping boot for ladders that has an elastic member having a pocket in the outer surface thereof and has a base of a greater thickness than the body thereof. The base has ribs formed on an outer face. An inner wall of the base is inclined from one end to the opposite end thereof. One of the end walls of the boot is separated from the side walls thereof.

U.S. Pat. No. 1,382,833, issued on Jun. 28, 1921 to Hurd, discloses a foot for stepladder legs that has a base plate turned up at its end to form parallel end walls. The side edges of the plate are formed with upwardly extending side walls. The side walls extend inwardly, then outwardly and are resilient. The side and end walls are substantially conterminous with the side and end edges of the base plate. The side and end walls form a socket to receive the leg of a ladder. The pad of rubber is disposed against the underface of the base plate and riveted thereto. The end walls extend at an angle relative to vertical and are parallel to one another.

U.S. Pat. No. 2,925,877, issued on Feb. 23, 1960 to Wright, discloses a top bumper attachment for a ladder having side rails that has bumper caps having sockets to fit onto the rails at the top, and a flexible strap extending between the facing sides of the caps. The flexible strap connects the facing sides of the caps as a unit. The width of the strap is vertically disposed. Non-slip nubs project from the front face of the strap.

U.S. Pat. No. 3,062,319, issued on Nov. 6, 1962 to Wright, discloses a non-mark, non-slip cap for the head end of a side rail of a ladder. The cap has a top, a front, a back and side walls. Vertically-formed spaced ribs project forwardly from the front wall. A cap snugly fits on the head end of the rail of the ladder. The cap is formed of a resilient material. The ribs are formed throughout the height of the front wall. The ribs have different facial widths for variations in resiliency of each of the ribs. Interconnecting spacers transversely connect the ribs adjacent the forward edges. Maximum resiliency is at the upper end and lower end, and the resiliency gradually diminishes to a degree of substantial rigidity at an intermediate area.

U.S. Pat. No. 3,115,212, issued on Dec. 24, 1963 to Keatley, discloses a safety bonnet for a ladder that has side rails that converge to a point on the upper end. The safety bonnet is placed over this upper end and has a molded rubber-like bonnet having an upper horizontal end and vertical side walls that form a chamber that receives the upper end of the side rails. The vertical side walls of the bonnet include a front wall and a back wall. The bonnet also has spaced side walls that extend between the front wall and the back wall. A pair of second side walls extend from the back wall to the inner surface of the cross piece of the ladder. An undersurface flap is foldable under the underside of the cross piece of the ladder. The under surface flap has an up-turned flange that is engageable with the back surface of the cross piece. A slip-resistant member is positioned on the outer surface of the walls for preventing slippage of the ladder against an extrinsic surface.

U.S. Pat. No. 3,662,856, issued on May 16, 1972 to D'Amico et al., discloses a ladder protector for a ladder having side rails wherein electrical and bearing functions are provided for each side rails by a flexible foam body member having resilient closed gas-filled cells. The protector includes elastic walls for easy assembly and removal of the protector from each end of the ladder rails.

U.S. Pat. No. 4,726,446, issued on Feb. 23, 1988 to Perbics, discloses a protection cover for a ladder that has front and rear side walls located over and extended between the upper end of the rails of a ladder. A releasable strap holds the cover on the ladder. Pads of resilient non-electrical conductive material are secured to the back side wall to protect the support surface for the ladder from the support. A pocket is secured to the front side wall to hold tools and like objects.

U.S. Pat. No. 4,771,862, issued on Sep. 20, 1988 to Garland, discloses a top ladder guard that is telescoped over the upper end of each of side rail of a ladder to provide a protective mounting against a vertical support wall structure. Each ladder guard is a single piece cup-shaped member which is molded of a suitable soft rubber-like plastic. Each guard includes a body portion of a rectangular cross section to fit over a side rail and an integral outer curved end wall having a substantially curved configuration. The body portion includes a pair of main side walls formed as an essentially smooth continuous member of an essentially constant thickness and a pair of narrow walls joining the main sidewall. The narrow walls are molded with a serpentine cross-section to form an accordion or expandable structure permitting expanding and contracting of the narrow walls. The narrow walls provide limited flexibility of the body portion for tight telescoping engagement with different sized side rails.

U.S. Pat. No. 4,899,848, issued on Feb. 13, 1990 to Parr, discloses a guard for the upper end of a ladder side rail that telescopes over the upper end to prevent the surface against which the ladder rests from being marred. The guard includes a rigid body and a resilient pad removably affixed to the body. The resilient pad engages the surface so as to prevent the marring. The resilient pad is replaceable as it loses its resiliency or otherwise wears out so that the entire guard does not have to be replaced.

U.S. Pat. No. 5,533,591, issued on Jul. 9, 1996 to Kiska, discloses a ladder rail cap that has a shell and a clip attached to an inner surface of the shell near a top end of the shell. The shell has an inside surface defining a chamber into which a ladder rail is disposed. The shell has a top end and a bottom end having an opening in communication with the chamber. The clip meets with the end cap of the ladder rail and penetrates the ladder rail so as to hold the shell onto the ladder rail.

U.S. Pat. No. 6,499,563, issued on Dec. 21, 2002 to Bremick, discloses a protective ladder cap for fitting over the end of a rail of a ladder. The cap has an open end for fitting over the rail and a closed end. The ladder cap has tapered internal ribs for engaging the end of a side rail of a ladder. The ladder cap prevents the ladder side rail from damaging the extrinsic surface upon which the ladder leans when in use.

It is an object of the present invention to provide an end cover for the rails of a ladder that grips extrinsic surfaces.

It is another object of the present invention to provide an end cover for the rails of ladders that is non-conductive.

It is another object of the present invention to provide an end cover for the rails of a ladder that can be grabbed by the user if the user happens to lose his or her balance while on the ladder.

It is still another object of the present invention to provide an end cover for the rails of a ladder that minimizes damage to extrinsic surfaces.

It is another object of the present invention to provide an end cover for the rails of a ladder that can be used to transport the ladder.

It is another object of the present invention to provide an end cover for the rails of a ladder that is lightweight.

It is still another object of the present invention to provide an end cover for the rails of a ladder that easily fits over the ends of the rails of the ladder.

These and other objects and advantages of the present invention will become apparent from a reading of the attached specification and appended claims.

### BRIEF SUMMARY OF THE INVENTION

The present invention is an end cover for a rail of a ladder comprising a body that has a front and a back and a first side and a second side and a top and a bottom, a hole formed in the body adjacent the back and the top, a tread affixed to the front, at least one pocket formed in the bottom of the body for accommodating an end of the rail of the ladder, a groove formed in the body extending from the bottom to the top, and a central planar portion extending downwardly from the bottom of the body. The groove has a rectangular cross section. The groove is adjacent the hole. The hole has an oval shape.

The front and the back of the body taper from the bottom to the top of the body. The pocket comprises a first pocket section formed in the body adjacent the front, a second pocket section formed in the body adjacent the second side, and a third pocket section formed in the body adjacent the back. The front has a first portion and a second portion. The first portion has a width greater than a width of the second portion. The tread is formed of a rubber material. The tread has a plurality of gripper sections extending outwardly from the front of the body. The body is formed of a polymeric or elastomeric material.

The end cover is positioned on and end of a rail of a ladder. The end of the rail of the ladder has a first section and a second section and a third section. The first section fits in the first pocket section of the body of the end cover. The second section fits in the second pocket section of the body of the end cover. The third section fits in the third pocket section of the body of the end cover. The central planar portion has a side adjacent the second section of the end of the rail of the ladder.

### BRIEF DESCRIPTION OF THE SEVERAL VIEWS OF THE DRAWINGS

FIG. 1 shows a perspective view of the preferred embodiment of the end cover of the present invention.

FIG. 2 shows a side elevational view of the end cover of the present invention.

FIG. 3 shows an opposite side elevational view of the end cover of the present invention.

FIG. 4 shows a front elevation view of the end cover of the present invention.

FIG. 5 shows a bottom view of the end cover of the present invention.

FIG. 6 shows a perspective view of an end cover of a ladder resting against an extrinsic surface.

### DETAILED DESCRIPTION OF THE INVENTION

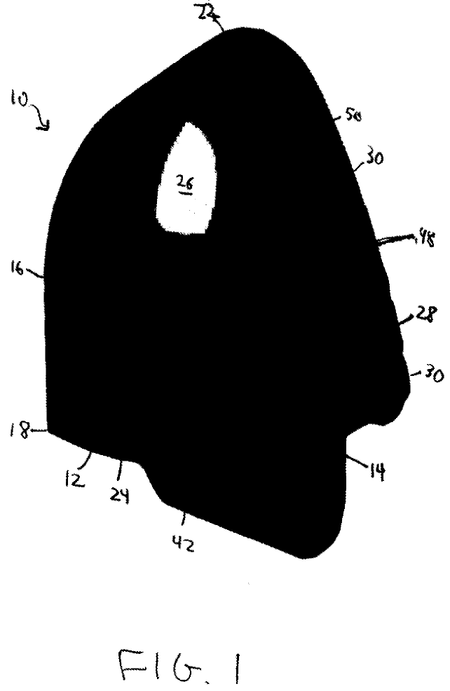

Referring to FIG. 1, there is shown the preferred embodiment of the end cover 10 of the present invention. The end cover 10 has a body 12. The body 12 has a front 14, a back 16, a first side 18, a second side (not shown), a top 22 and a bottom 24. A hole 26 is formed in the body 12 adjacent the back 16 and the front 14 of the body 12. A groove 40 is formed in the body 12 and extends from the bottom 24 to the top 22 of the body 12. The groove 40 is adjacent the hole 26. Moreover, the groove 40 is positioned between the front 14 of the body 12 and the hole 26. The groove 40 has a rectangular cross-section. A central planar portion 42 extends downwardly from the bottom 24 of the body 12. A tread 28 is affixed to the front 14 of the body 12. The tread 28 has gripper sections 30 that extend outwardly from the front 14 of the body 12. The front 14 and back 16 taper from the bottom 24 to the top 22 of the body 12. The front 14 of the body 12 has a first portion 48 and a second portion 50. The first portion 48 has a width that is greater than a width of the second portion 50. The tread 28 is generally formed of a polymeric or elastomeric material, such as a rubber material. The body 12 is generally formed of a polymeric material.

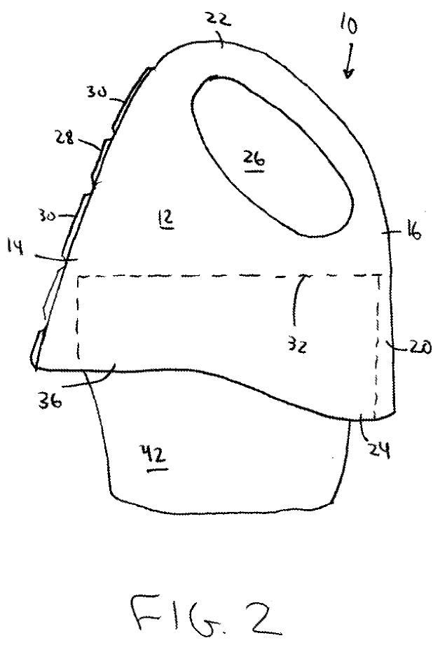

Referring to FIG. 2, there is shown a side elevational view of the end cover 10 of the present invention, as viewed from the second side 20 of the end cover 10. As can be seen, the hole 26 is oval in shape. The oval shape of the hole 26 is specially designed to minimize the size of the body 12 of the end cover while providing maximum space for the fingers of a ladder user. The broken line shows the pocket 32 that is formed in the bottom 24 of the body 12. The groove cannot be seen from the second side 20 because the groove is formed only in the first side of the body 12. The central planar portion 42 can be seen as extending downwardly from the bottom 24 of the body 12. The central planar portion 42 is not wider than the pocket 32. The front 14 of the body 12 extends at an angle relative to the pocket 32. As a result, the gripper section 30 of the tread 28 efficiently grasp a support surface, or extrinsic surface, when the end cover 10 is used on the ends of the rails of a ladder. A tread 28 can have any number of gripper sections so as to have a suitable number for gripping an extrinsic surface. As can be seen in FIG. 2, the gripper sections 30 can be of different sizes. The gripper sections 30 of the tread 28 are generally formed of a rubber material so as to resiliently hold the end cover 10 against an extrinsic surface. The rubber material of the tread also prevents damage to an extrinsic surface by providing a resilient buffer between the extrinsic surface and the end cover 10.

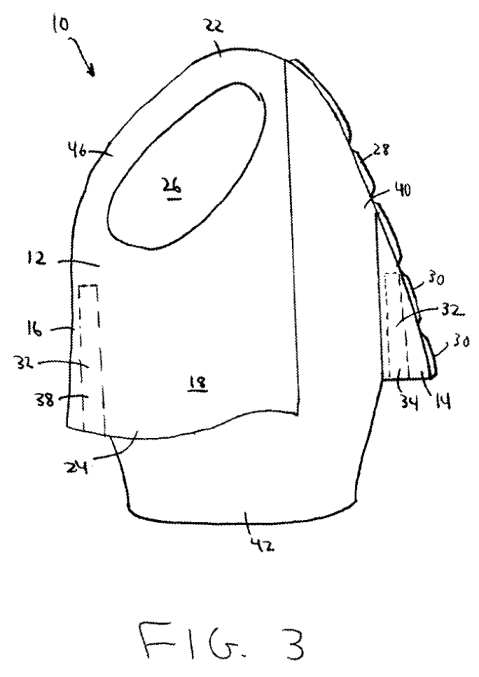

Referring to FIG. 3, there is shown an opposite side elevational view of the end cover 10 of the present invention, as seen from the first side 18. Groove 40 extends from the bottom 24 to the top 22 of the body 12. The first pocket section 34 and the second pocket section 38 are illustrated with broken lines. The first pocket section 34 of the pocket 32 is adjacent the front 14 of the body 12. The third pocket section 38 of the pocket 32 is adjacent the back 16 of the body 12. The hole 26 is oval in shape so as to form a handle 46 in the top 22 of the body 12. The handle 46 can be grasped by a user ladder so as to maintain or regain balance on the ladder. The handle 46 can also be used to transport the ladder. The first pocket section 34 and third pocket section 38 are formed inwardly of the body 12 at the same distance from the bottom 24. The body 12 is made of a polymeric or elastomeric material, which is non-conductive. Moreover, the tread 28 is made of a rubber material or other elastomeric material that is non-conductive. Thus, the end cover 10 of the present invention is non-conductive and protects the user of a ladder from electrical shock.

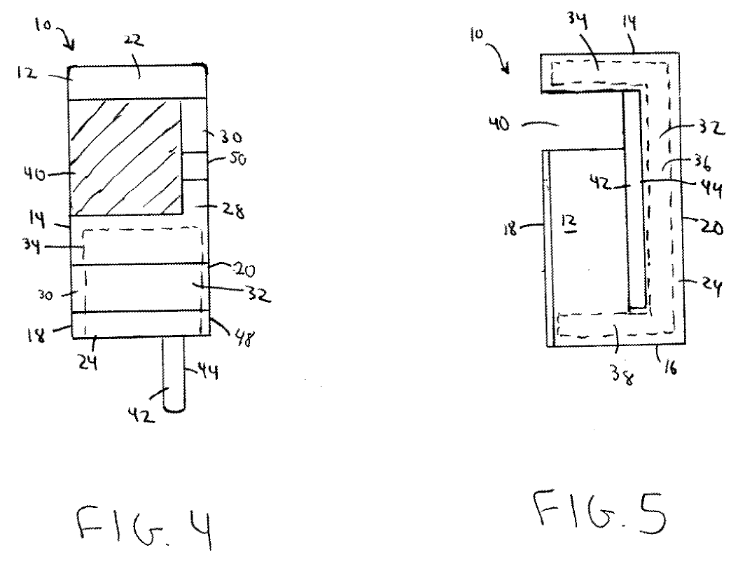

Referring to FIG. 4, there is shown a front elevational view of the end cover 10 of the present invention. The first portion 48 of the front 14 of the body 12 is illustrated as having a width greater than the width of the second portion 50 of the front 14. Thus, the groove 40 can be seen from the front 14 of the body 12. The top 22 of the body 12 curves downwardly toward the groove 40. The gripper sections 30 of the tread 28 are illustrated as having a different sizes. The different sizes of the gripper sections 30 help the tread 28 to adhere to any extrinsic surfaces. The central planar portion 42 extends downwardly from the bottom 24 of the body 12. The broken line shows the first pocket section 34 of the pocket 32. A side 44 of the central planar portion 42 is adjacent the ladder rail when the end of the ladder rail is inserted into the pocket 32 of the end cover 10. The central planar portion 42 gives the end cover 10 added rigidity and durability when the end cover 10 is mounted on an end of a rail of a ladder. The central planar portion 42 is closer to the second side 20 than it is to the first side 18 of the body 12.

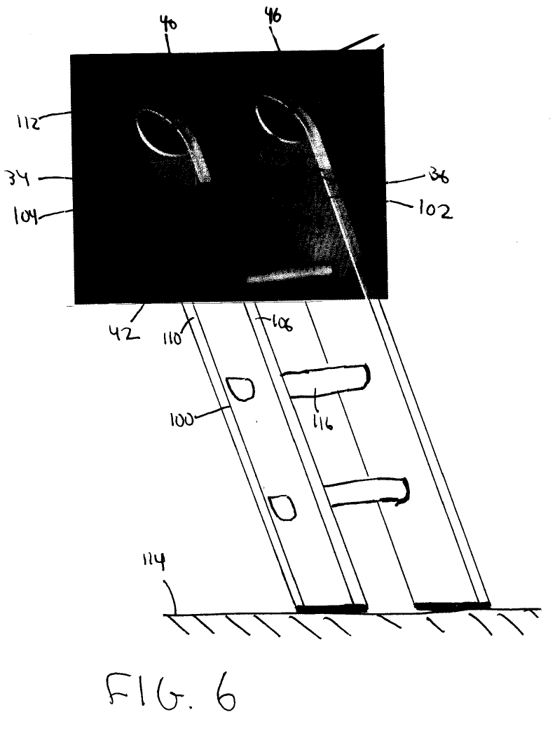

Referring to FIG. 5, there is shown a bottom view of the end cover 10 of the present invention. The groove 40 has a rectangular cross-section. The pocket 32 extends into the bottom 24 of the body 12. The pocket 32 is shown with broken lines. The pocket 32 has a first pocket section 34, a second pocket section 36 and a third pocket section 38. The first pocket section 34 is adjacent the front 14 of the body 12. The second pocket section 36 is adjacent the second side 20 of the body 12. The third pocket section 38 is adjacent the back 16 of the body 12. The pocket 32 is generally U-shaped so as to accommodate the shape of the rail of the ladder. It can be seen how the side 44 to the central planar portion 42 will be adjacent the ladder rail once the ladder rail is inserted into the pocket 32. The groove 40 is formed in the body 12 of the end cover 10 so as to minimize the weight and material need to form the end cover 10 without sacrificing the structural rigidity of the body 12 of the end cover 10.

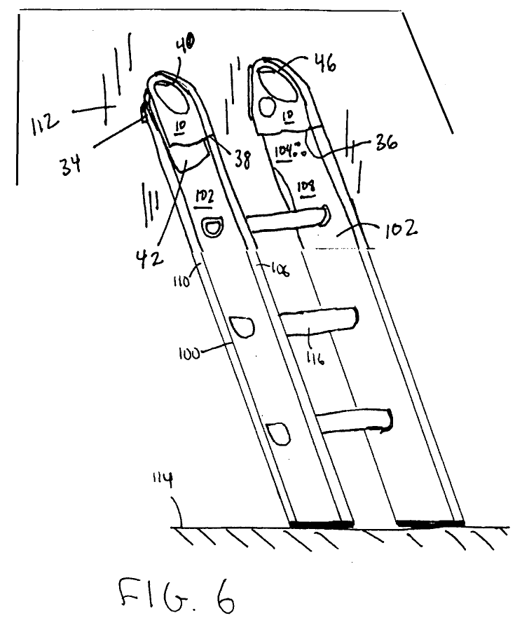

Referring to FIG. 6, there is shown a perspective view of a ladder 100 having end covers 10 on the ends 104 of the rails 102. The end covers 10 of the ladder 100 rest against an extrinsic surface 112. The bottom of the ladder 100 rests on the ground 114. Like typical ladders, the ladder 100 has side rails 102 with rungs 116 extending perpendicularly therebetween. The end 104 of the rail 102 of the ladder 100 extends within the first pocket section 34, second pocket section 36, and third pocket section 38 of the pocket 32 of the end cover 10. The ladder rail 102 has a first section 106, a second section 108, and a third section 110. The first section 106 of the rail 102 fits within the first pocket section 34 of the end cover 10. The second section 108 of the rail 102 fits within the second pocket section 36 of the end cover 10. The third section 110 of the rail 102 fits within the third pocket section 38 of the end cover 10. As used with ladder 100, end cover 10 protect the extrinsic surface 112 from damage and markings due to the rubbing of the ends 104 of the rails 102 of the ladder 100 against the extrinsic surface 112. The handles 46 of the end cover 10 make the end covers 10 easy to grab by the user of the ladder 100 in the case that the user loses his or her balance or needs other support while on the ladder 100. The non-conductive material of the end cover 10 prevents the flow of electricity between the extrinsic surface 112 and the ladder 100. The handles 46 of the end covers 10 can also be used to transport the ladder 100 from location to location.

The foregoing disclosure and description of the invention is illustrative and explanatory thereof. Various changes in the details of the illustrated construction can be made within the scope of the present claims without departing from the true spirit of the invention. The present invention should only be limited by the following claims and their legal equivalents.

I claim:

1. An end cover for a rail of a ladder comprising:
a body having a front and a back and a first side and a second side and a top and a bottom;
a hole formed in said body adjacent said back and said top;
a tread affixed to said front; and
a pocket formed in said bottom of said body, said pocket having a shape and size suitable for accommodating an end of the rail of the ladder.

2. The end cover of claim 1, further comprising:
a groove formed in said body, said groove extending from said bottom to said top.

3. The end cover of claim 2, said groove having a rectangular cross section, said groove being adjacent said hole.

4. The end cover of claim 2, further comprising:
a central planar portion extending downwardly from said bottom of said body.

5. The end cover of claim 1, said front and said back of said body tapering from said bottom to said top of said body.

6. The end cover of claim 1, said pocket comprising:
a first pocket section formed in said body adjacent said front;
a second pocket section formed in said body adjacent said second side; and
a third pocket section formed in said body adjacent said back.

7. The end cover of claim 1, said front having a first portion and a second portion, said first portion having a width greater than a width of said second portion.

8. The end cover of claim 1, said tread being formed of an elastic material.

9. The end cover of claim 8, said tread having a plurality of gripper sections extending outwardly from said front of said body.

10. The end cover of claim 9, said plurality of gripper sections having different lengths extending outwardly from said from of said body.

11. The end cover of claim 1, said hole having an oval shape.

12. An apparatus comprising:
a ladder having at least one rail; and
an end cover positioned on an end of the rail, said end cover comprising:
a body having a front and a back and a first side and a second side and a top and a bottom;
a tread affixed to said front; and
a pocket formed is said bottom of said body for accommodating an end of the rail of the ladder.

13. The apparatus of claim 12, said end cover further comprising:
a hole formed in said body adjacent said back and said top.

14. The apparatus of claim 13, said end cover further comprising:
a groove formed in said body, said groove extending from said bottom to said top, said groove having a rectangular cross section, said groove being adjacent said hole.

15. The apparatus of claim 12, said front and said back of said body tapering from said bottom to said top of said body.

16. The apparatus of claim 15, said front having a first portion and a second portion, said first portion having a width greater than a width of said second portion.

17. The apparatus of claim 12, said pocket comprising:
a first pocket section formed in said body adjacent said front;
a second pocket section formed in said body adjacent said second side; and
a third pocket section formed in said body adjacent said back.

18. The apparatus claim 17, said end of said rail of said ladder having a first section and a second section and a third section, said first section fitting in said first pocket section of said body of said end cover, said second section fitting in said second pocket section of said body of said end cover, said third section fitting in said third pocket section of said body of said end cover.

19. The apparatus of claim 18, said end cover having a central planar portion extending downwardly from said bottom of said body, said central planar portion having a side adjacent said second section of said end of said rail of said ladder.

20. The apparatus of claim 12, said tread being formed of an elastomeric material, said tread having a plurality of gripper sections extending outwardly from said front of said body, said plurality of gripper sections having different lengths extending outwardly from said front of said body.
